(19) United States
(12) Patent Application Publication
(10) Pub. No.: US 2020/0183884 A1
(43) Pub. Date: Jun. 11, 2020

(54) CONTENT-AWARE SEARCH SUGGESTIONS

(71) Applicant: Microsoft Technology Licensing, LLC, Redmond, WA (US)

(72) Inventors: Bernhard S.J. KOHLMEIER, Seattle, WA (US); Madeline Schuster KLEINER, Mercer Island, WA (US); Nathaniel George FREIER, Seattle, WA (US)

(21) Appl. No.: 16/212,282

(22) Filed: Dec. 6, 2018

(51) Int. Cl. G06F 16/14; G06F 16/13; G06F 16/2457

(52) U.S. Cl. CPC G06F 16/144; G06F 16/13; H04L 67/18; G06F 16/24578; G06F 16/148

(57) ABSTRACT

Content-aware search suggestions can be provided by performing entity extraction on content in a file that a user is consuming, authoring, or editing; storing the extracted entities in an index; and generating terms and phrases related to the extracted entities and storing the terms and phrases in the index. In response to receiving an input of at least one character in a search field: a set of search suggestions can be provided based on the terms and phrases that appear in the index that satisfy a condition with respect to the at least one character from the input.

### BACKGROUND

Suggestions, or predictions, may be provided when a user begins entering characters in a search field. Auto-suggest and auto-complete input fields provide a useful functionality that enable a user to generate a query or phrase in fewer strokes (e.g., keystrokes) and, in some cases, can assist in query or phrase creation.

In general, a suggested query or phrase uses a variety of signals to generate one or more predictions for what the user is entering as the query or phrase. For search, these signals tend to involve user history (the user's own search history and/or a community of users' search history) and the characters or words currently in the search field. The user's geographical location and language can also play a part in the particular suggestions.

### BRIEF SUMMARY

Content-aware search suggestions are provided. The described techniques and systems involve informing search suggestions based on the content being consumed or authored by the user of the search function.

A method for content-aware search suggestions includes performing entity extraction on words in a file that a user is consuming or editing; storing the extracted entities in an index; generating terms related to the extracted entities and storing the terms in the index; and in response to receiving an input of at least one character in a search field: providing a list of suggestions based on the terms that appear in the index that satisfy a condition with respect to the at least one character from the input. In some cases, suggestions can be provided prior to receipt of the input of the at least one character. These prior-to-at-least-one-character suggestions can be based on criteria with respect to the content of the file.

The content-aware search suggestions can be incorporated in a search feature of a content creation or consumption application such as, but not limited to, a notetaking application, word processing application, a reader application, a graphic design application, or a video editor application. In some cases, the content-aware search suggestions can be incorporated in search field functionality for a search engine (either directly by being based on content in the browser or indirectly by being based on content being consumed or authored in a separate application).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a process flow for facilitating content-aware search suggestions.

FIG. 2 illustrates an example environment that may be leveraged by the process of FIG. 1.

FIGS. 3A and 3B show example graphs that may be used to inform the content-aware search suggestions. FIG. 3A shows an enterprise graph and FIG. 3B shows a graph representing content corpora.

FIGS. 4A-4B, 5A-5B, 6A-6B, and 7 provide illustrative scenarios in which processes for facilitating content-aware search suggestions are carried out.

FIG. 8 illustrates a process flow diagram for content-aware search suggestions.

FIGS. 9A and 9B provide an illustrative scenario of content-aware search suggestions.

FIGS. 10A-10E illustrate an example system and operations for content-aware search suggestions.

FIG. 11 illustrates an operating environment for content-aware search suggestions.

FIG. 12 shows an example computing system that may carry out the described content-aware search suggestions.

### DETAILED DESCRIPTION

Content-aware search suggestions are provided. The described techniques and systems involve informing search suggestions based on the content being consumed or authored by the user of a search feature. The content being consumed may be that authored by the user, one or more other users, or some other entity.

The content-aware search suggestions can be incorporated in a search feature of a content creation or consumption application. In some cases, the content-aware search suggestions can be incorporated in search field functionality for a search engine.

When a user performs a search in the context of a content creation or productivity application (e.g., note taking, word processing, presentation, and the like), they can be looking for commands, product help, or other related information. One way to help the user complete their search intent faster is with query suggestions that “auto-complete” the user's query. When the user clicks on the suggested search term(s), then the user can accomplish their task faster. By incorporating the described content-aware search suggestions, the user's own authored content or simply content that the user is consuming or interacting with (or even other “related” content) can be used as data to generate the search suggestions. In this environment, search suggestions can thus also be made relevant to that particular user and that user's productivity task. Of course, implementations are not limited thereto.

Rather than, or in addition to, using query history as the data source for query suggestions of a search feature, the search feature can use the content a user is consuming or authoring. For example, if a user is writing or consuming a document about the great apes, it is this content that informs the query suggestions such that if the user enters “pri” into a search field, the content regarding the great apes informs the suggestion of “primate” as part of the search.

The very fact that a user is consuming or interacting with some content, leads to the supposition that the user is more likely to have a question or want to know more about that content, particularly at the time the user is consuming the content.

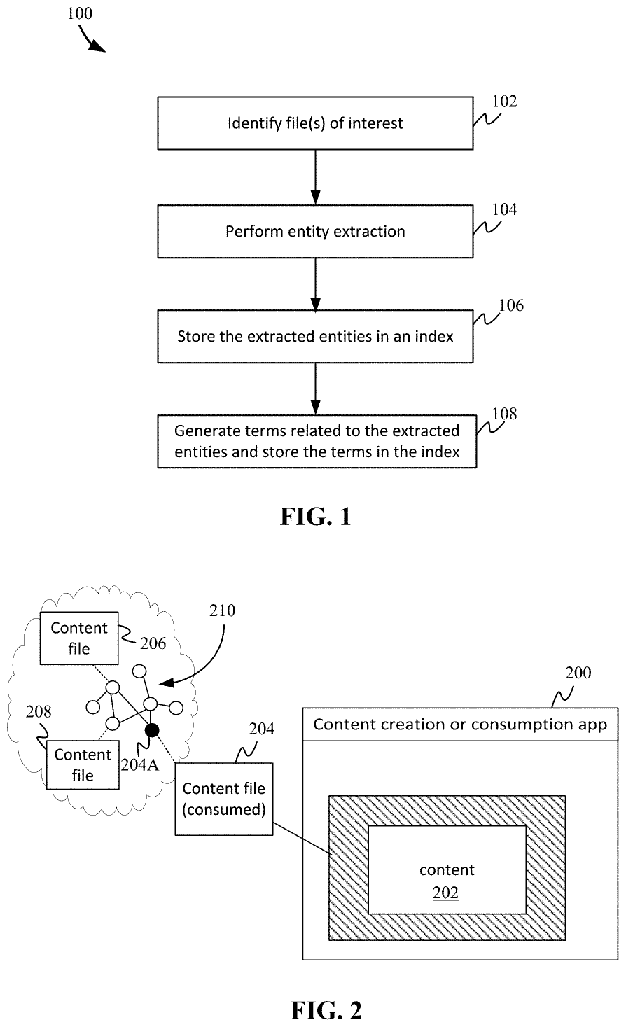

FIG. 1 illustrates a process flow for facilitating content-aware search suggestions; and FIG. 2 illustrates an example environment that may be leveraged by the process of FIG. 1. Referring to FIG. 1, process 100 can include identifying file(s) of interest (102); and performing (104) entity extraction from the file(s) of interest, for example, from the file that a user is consuming, authoring, or editing. The extracted entities can be stored (106) in an index; and the system can generate (108) terms and phrases related to the extracted entities and store those terms in the index. One or more topics of the content in the file can also be determined from the terms extracted from the file, and terms and phrases related to the topic(s) determined from the file can be generated and added to the index. In some cases, additional terms can be obtained through semantic analysis.

The index can be updated as a user is authoring content. For example, when a modification is received to the content in a file, the index can be updated based on the modification to the content in the file (e.g., by adding or removing terms/phrases). The modification may be an addition of new content or removal of existing content as some examples.

In some cases, the index can be stored as part of the metadata of the file. This can allow for other users or other instances of consuming the file to have the advantage of the prior processing to generate the index.

A file of interest refers to a file that contains the content used to generate the content-aware search suggestions—and that is itself consumable (or even currently being consumed or authored as reflected in the example of FIG. 2) by a user. In addition, the files of interest are generally intended to be consumable in a content creation or content consumption application (e.g., app 200 of FIG. 2). The “file of interest” does not refer to files or messages created in an intermediate process of generating search queries from a user input (e.g., files that may contain history logs, files of prior queries) or index files created by search bots that indicate information of a website.

A “content consumption application” refers to any application in which content can be consumed (e.g., by viewing or listening). In some cases, content consumption applications include editing functionality and may include content creation applications. Examples of content consumption applications include document viewers (e.g., a PDF viewer), email applications, reader applications (e.g., e-book readers), presentation applications, word processing applications, web browser applications, audio players (spoken audio and music), video players, notebook applications, browser, and whiteboard applications.

Content creation applications are software applications in which users can create content in digital form. Examples of content creation applications include, but are not limited to, note-taking applications such as MICROSOFT ONENOTE and EVERNOTE, freeform digital canvases such as GOOGLE JAMBOARD and MICROSOFT Whiteboard, word processing applications such as MICROSOFT WORD, GOOGLE DOCS, and COREL WORDPERFECT, presentation applications such as MICROSOFT POWERPOINT and PREZI, as well as various productivity, computer-aided design, blogging, and photo and design software. As is apparent from the examples, a content consumption application may also be considered a content creation application (or even a productivity application) and vice versa. Indeed, content consumers may use content creation applications, communication applications (e.g., email, messaging applications, and the like), reader applications, and even web browsers to consume content.

Referring to FIG. 2, a file of interest may be a portion of a content file (e.g., the portion 202 being displayed or played in a content creation or consumption application 200), the entire content file 204 that contains the portion 202 being displayed (or played), and, either in addition or as an alternative, content (e.g., content 206 and/or content 208) determined to be relevant to (or otherwise related to) the content file 204. Entities can be extracted from one or more of these files. Indeed, entities can be extracted from both the content file 204 being consumed and from content (e.g., files 206, 208) determined to be “related” to the content 204 the user is consuming, authoring, or editing. When creating the index, the system can request related content, either from storage or from an external source or service. In some cases, relationships (or “links” or “connections”) between content can be searched to identify the related content. For example, the content file 204 may be represented as a node 204A in a graph 210 and linked content can be identified from the graph 210.

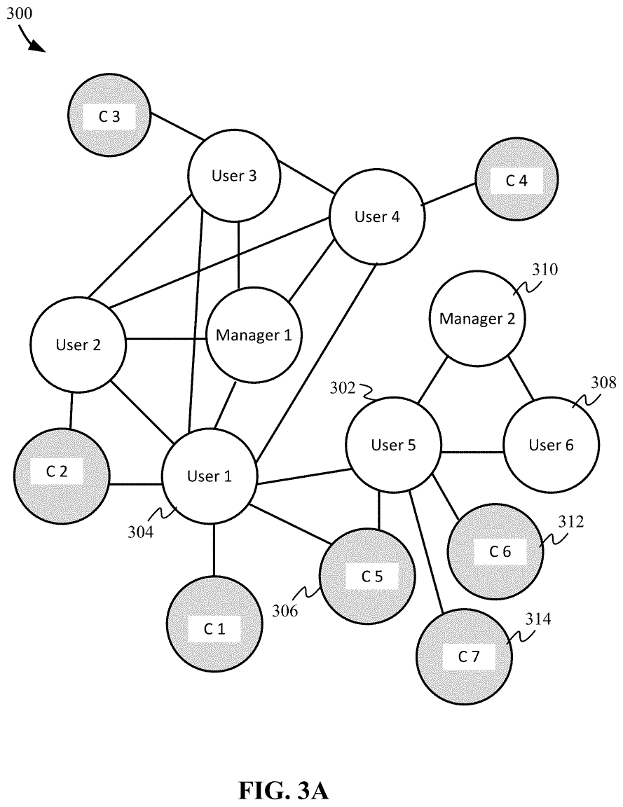

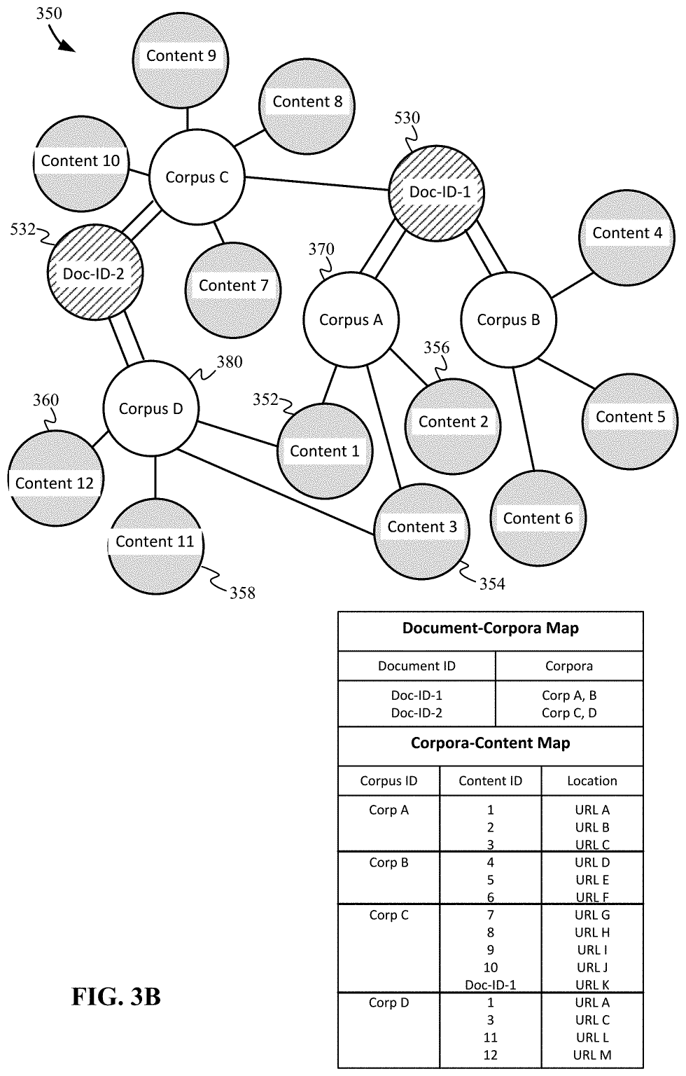

Content determined to be relevant to (or otherwise related to) the content file can be identified based on links between users, links between content that indicate reuse and/or origination of content, links between content (linked for other purposes), and links between users and content. Examples of relationships between users and content (and content and content) are described with respect to FIGS. 3A and 3B.

FIGS. 3A and 3B show example graphs that may be used to inform the content-aware search suggestions. The graphs shown in FIGS. 3A and 3B are two examples of graphs that may be used to implement graph 210. It should be understood that although the content nodes may be presented to a system as unique nodes, in some implementations, the nodes may be algorithmically collapsed based on, for example machine learning or other patterns or identifiers, thereby increasing the number of times multiple documents point to the same content. The arrangement of the nodes can affect the manner of traversal.

FIG. 3A shows an enterprise graph. Referring to FIG. 3A, an enterprise graph 300 can include nodes representing users and nodes representing content. The nodes representing users can be connected based on relationships of the users (e.g., based on their roles or organizational structure). In some cases, nodes of users can be connected to other users based on interactions with each other and even based on interactions with the content that itself is connected to a user. For example, user 5 302 can be connected to user 1 304 due to interactions of both user 1 304 and user 5 302 with content 5 306. The interactions can include viewing, authoring, editing, and reusing (e.g., inserting into another file or saving as another file). Thus, if user 5 302 authored content 5 306 and user 1 reused content 5 306, then (depending on the specific rules of that graph) user 1 304 can be connected to user 5 306 even though user 1 304 and user 5 302 do not share the same manager. Here, both user 5 306 and user 6 308 are connected to manager 2 310, and user 5 306 and user 6 308 can be connected to each other based on their position in the organization (e.g., on same team).

Although not shown, content can be connected within the graph structure as well. The nodes representing content can be of any suitable granularity, for example, representing a file of content or a subset of content from a file (e.g., a paragraph from a file with multiple paragraphs, an image from a file with an article, etc.).

Accordingly, in some cases, the system can extract entities from content having a particular relationship to the user or to the content itself; and those entities can be added to the index to inform search suggestions.

A system incorporating the content-aware search suggestions can use the graph 300 to identify other files as related files with respect to the file (or even with respect to the user or users to which that user is connected with); and use those at least one of those other files to generate terms and phrases for the index (e.g., by performing (104) entity extraction on that related file, storing (106) the extracted entities in the index, and generating (108) terms and phrases related to the extracted entities). This robust index can then be used to provide the list of suggestions. In some cases, a related file (e.g., content 5 306) might be considered related to the file a user is consuming by being related directly to the user consuming the file. The related file (e.g., content 5 306) can be considered to be related directly to the user consuming the file based on that user's content authoring, reuse, editing, viewing, or other interactions. For instance, the system could consider related any files (e.g., content 306, 312, 314) that have the same author (e.g., user 5 302). As another example, the system could also consider related any files that are connected to a user that is themselves connected to the user consuming the file. In some cases, the system can consider related any files that are connected to other users who are connected to the original user, where those other users are those that the original user often collaborates with (and are of related topics as determined by a topic analysis of those files). A similar process can be done that connects users that often co-author content to create a single corpus from which to pull.

FIG. 3B shows a graph representing content corpora. Also shown in FIG. 3B is a legend or alternate representation of content corpora. Here, a content corpus (plural “content corpora”) refers to the grouping of content that may be automatically assigned or author-assigned to a document or other file as being relevant to the content in that document or other file. In this manner, related files could include other files assigned to one or more content corpora attached/associated with the original file, such as described in application Ser. No. 15/926,668, filed Mar. 20, 2018, and Ser. No. 15/926,500, filed Mar. 20, 2018, which are incorporated herein by reference.

Referring to FIG. 3B, a graph 350 can include nodes representing a mapping between a document and its attached corpora (which indicate the content assigned to that corpus). Here, a first document (Doc-ID-1) is shown having corpora A and B attached thereto. A second document (Doc-ID-2) is shown having corpora C and D attached thereto. As can be seen from the mapping, the same content can be included in different corpora, multiple corpora can be attached two different documents, and documents having themselves attached corpora can be included in another corpus.

For instance, Content 1 352 and Content 3 354 are both part of both Corpus A 370 and Corpus D 380, but Content 2 356 is only part of Corpus A 370. Corpus A 370 is associated with Document 1 390 and Corpus D is associated with Document 2 392. In this context, if the particular content being consumed, authored, or edited by the user is Document 1 390, a service that finds related documents might return all or part of Content 1 352, Content 2 356, and Content 3 354. However, if the particular content being consumed, authored, or edited by the user is Document 2 392, then all or part of Content 1 352, Content 3 354, Content 11 358, and Content 12 360 might be returned.

A system incorporating the content-aware search suggestions can use the graph 350 to identify other files (or parts of files) as related files with respect to the file (or even with respect to the author of the content having the content corpora attached thereto). The identified files can be used to generate terms and phrases for the index (e.g., by performing (104) entity extraction on that related file, storing (106) the extracted entities in the index, and generating (108) terms and phrases related to the extracted entities). This robust index can then be used to provide the list of suggestions.

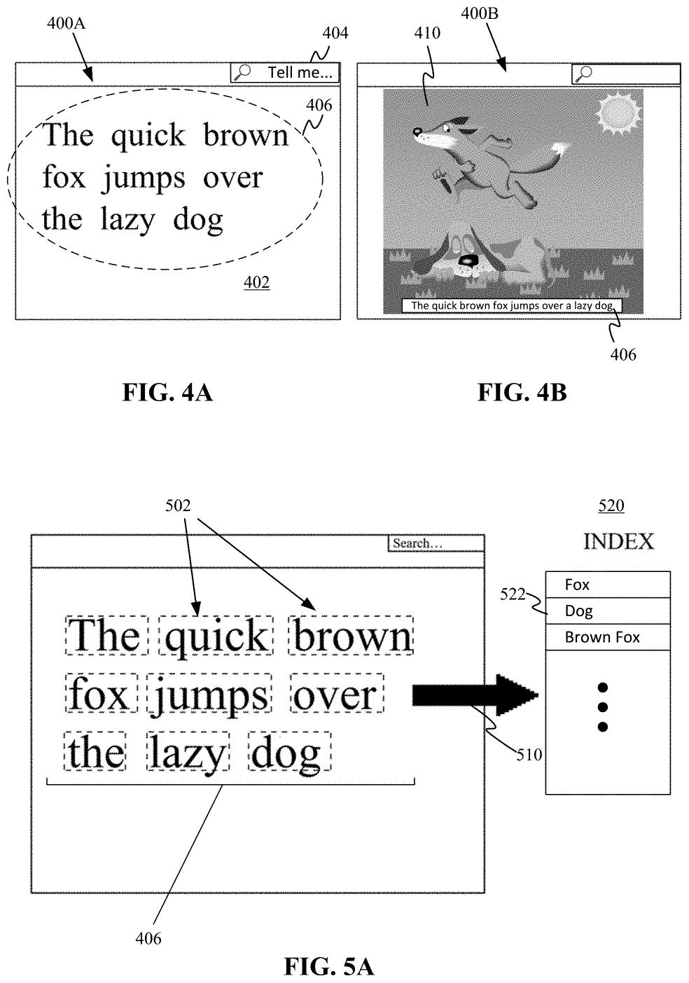

FIGS. 4A-4B, 5A-5B, 6A-6B, and 7 provide illustrative scenarios in which processes for facilitating content-aware search suggestions are carried out. FIGS. 4A-4B, 5, and 6A-6B represent scenarios with different media files that may be used to facilitate content-aware search suggestions.

FIGS. 4A and 4B show a starting view of a UI 400A, 400B in which a user is consuming content. The UI 400A, 400B could be for any content consumption or creation application such as described with respect to application 200 of FIG. 2. Content is displayed (and may be authored or edited) in a canvas 402 of the application.

The application can also have a built-in search feature 404. The built-in search feature 404 may be the entry for any number of in-context search functions. For example, the search feature 404 may be the “Tell Me” box available for MICROSOFT OFFICE and MICROSOFT SEARCH.

In the example of FIG. 4A, the content displayed in the canvas 402 includes text 406; and in the example of FIG. 4B the content displayed in the canvas 402 includes both text 406 and images 410. The media file with the text 406 and images 410 may be a document file format (e.g., .docx, html, pdf), presentation file format, a video file format, an image file format, or other suitable format.

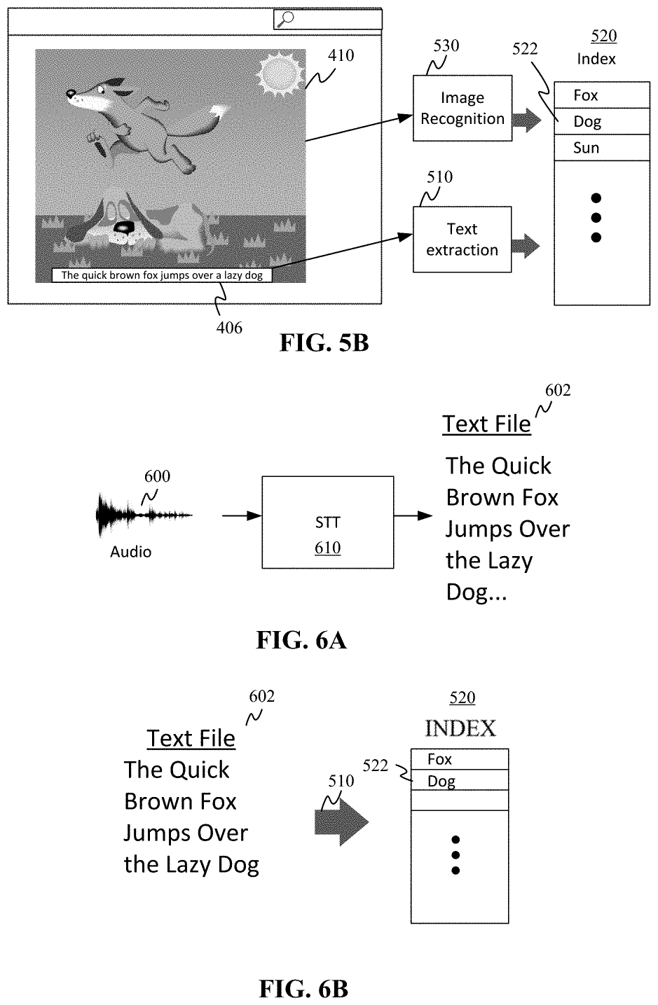

FIG. 5A reflects the process of entity extraction from text content, and storage of the entities in an index. FIG. 5B reflects the process of entity extraction from media content that includes images. As illustrated in FIG. 5A, words 502 can be identified from the text 406; and entities can be identified and extracted (510).

Words 502 may be identified by syntaxic and/or semantic analysis and the words or phrases corresponding to recognized entities (or groupings of entities that identify a topic) can be stored in an index 520. Any suitable extraction rules or techniques may be used to extract entities in the text, for example, pattern matching, linguistics, syntax, semantics or a combination of approaches may be used. Stop words can be excluded from the index 520. In some cases, the list of stop words could be actively curated by a user, provided automatically by the application or a service, or a combination thereof. The list of stop words could also vary based on context. In some cases, duplicate terms could be denoted in some way. For example, a weight of attribute can be included in the index to denote that a term is found multiple times.

The specific data structure used to store index 520 may be any suitable structure that supports editing, and that can contain representations of the entities, such as the term 522 “Dog”, or groups of words (e.g., “brown fox”) or phrases (not shown).

As illustrated in FIG. 5B, entities may be extracted from images, for example, by performing image recognition (530). Any suitable image recognition process may be performed. In the illustrated example, the image recognition process may identify “fox”, “dog”, and “sun”; and store those terms in the index 520. For the text 406, as described with respect to FIG. 5A, entities can be identified and extracted (510). Duplicates may be denoted (e.g., “fox” and “dog” may be identified from both the image and the text and stored in the index with some indication that the terms are provided multiple times).

For any file, the scope of the region from which the entities are extracted can vary in size, as described with respect to FIG. 2. For example, the scope could include all the content in the currently viewed file. The scope could include only a subsection of the content, for instance, only the current chapter, current section, or only the content that is currently visible in the UI (e.g., UI 400A, 400B of FIGS. 4A and 4B). In some cases, the scope includes related files (and can include related files of any media type). In some cases, related files can provide additional content from which entities can be extracted. In some cases, the related files are files having a predetermined relationship as identified using an enterprise graph or even a social graph.

Accordingly, in some cases, the entity extraction is performed on the entire content of the file. In some cases, the entity extraction is performed on some subset of the content in the file. For example, the subset of the content can be all the content in a current display. In some cases, the subset may be the content currently in the view of the display as well as a portion not seen. In some cases, entity extraction can be performed on related files (e.g., those files determined to be related, such as described with respect to FIGS. 2 and 3A-3B).

FIGS. 6A and 6B illustrate an example scenario with a media file containing audio. Referring to FIG. 6A, an audio file 600 can be transformed into a text file 602 via speech-to-text (STT) program 610. The STT program 610 may be part of the content consumption/creation application or a service that the content consumption/creation application can communicate with. Then, as illustrated in FIG. 6B, the text file 602 can be processed to extract the entities (e.g., operation 510); and the entities (words and phrases) can be stored in the index 520.

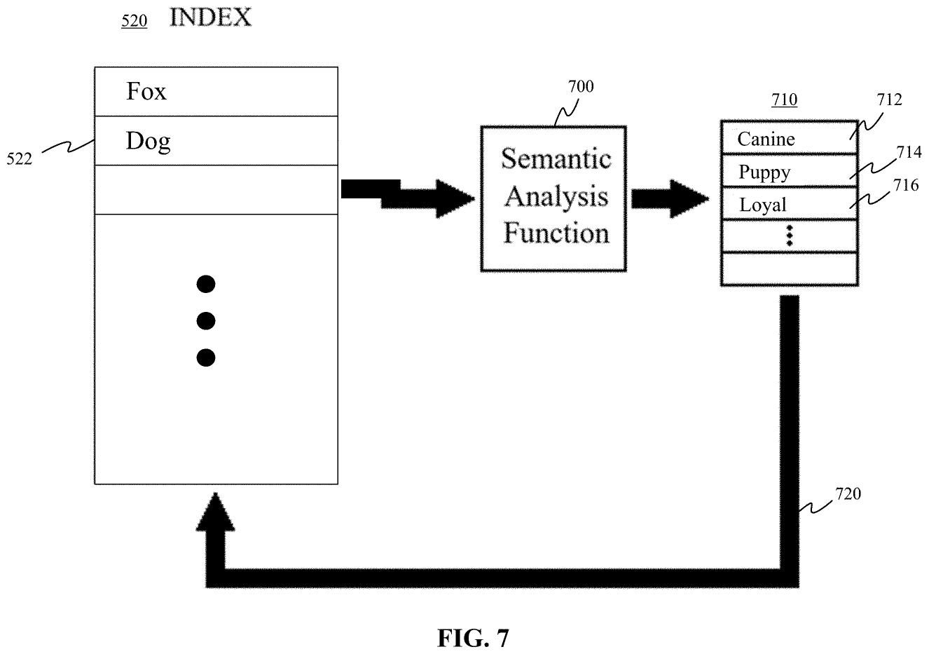

FIG. 7 reflects the process of generating terms related to the extracted entities and storing those terms in the index. As illustrated in FIG. 7, a semantic analysis function 700 can be used to find semantically related terms 710 expanding the index beyond the literal words that appear in the text. Function 700 represents a system or module that performs semantic analysis (and which may access online ontologies and services) to identify semantically related terms to those terms already in the index from the content of the file being consumed, authored, or edited. Inclusion of semantically related terms supports suggestions that are informed by the concepts expressed in the file and not just the literal text.

In the illustrated example, term 552 “Dog” can be used (in some cases along with n-gram context analysis) to generate related terms 710 of “Canine” 712, “Puppy” 714, “Loyal” 716, and others. It should be understood that although single words are shown, sentences and phrases may be generated and stored in the index. The related terms 710 can be added (720) to the index 520. The semantic analysis may be carried out for all terms in the index 520 or, in some cases, for the terms that meet certain criteria such as having an occurrence in the content at least above a specified number of times.

Index 520 can be dynamic—in that the index may be generated or updated any time the content being consumed, authored, or edited changes. For example, if the user adds or removes content; or if the user scrolls or otherwise views a different portion of the file.

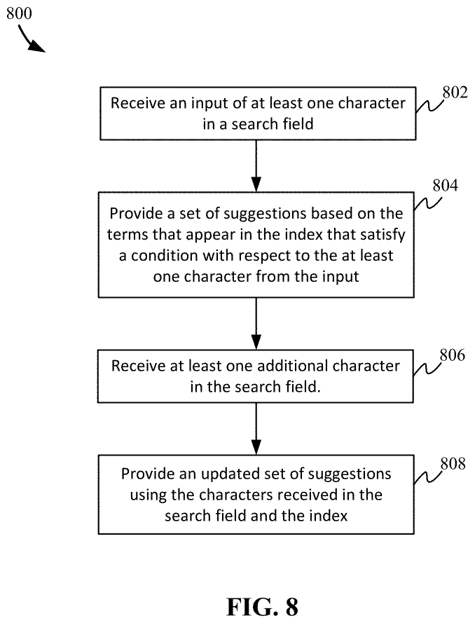

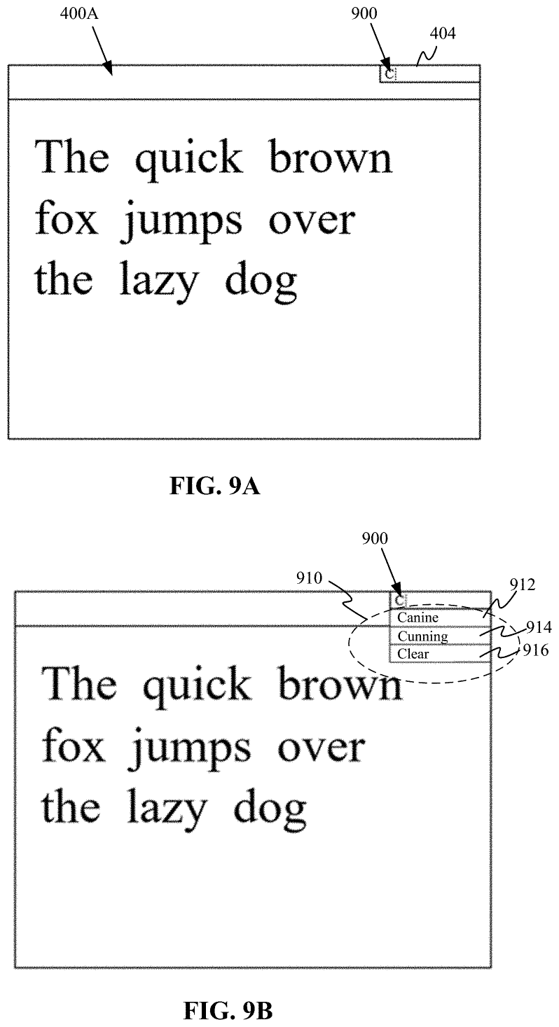

FIG. 8 illustrates a process flow diagram for content-aware search suggestions; and FIGS. 9A and 9B provide an illustrative scenario of content-aware search suggestions.

The index created as described with respect to operations 104, 106, and 108 of FIG. 1 (and FIGS. 4A-4B, 5A-5B, 6A-6B, and 7) can be used to provide search suggestions. For example, referring to FIG. 8, an input of at least one character can be received (802) in a search field (e.g., via search feature 404); and a set of suggestions can be provided (804) based on the terms that appear in the index that satisfy a condition with respect to the at least one character from the input. Additional characters can be received (806) in the search field; and an updated list of suggestions can be provided (808).

Referring to FIG. 9A, which shows a snapshot state of UI 400A, a user might have a question about the material they are consuming, authoring, or editing. The user can use the search feature 404 to find out more. As previously described, the search feature 404 can be integrated into the content creation or consumption application. In some cases, the search feature 404 is an add-on, plug-in, or some other program that communicates with the content creation or consumption application. When one or more characters 900 are entered into a search field 404, for example, the character “C”, a set 910 of suggestions (e.g., “canine” 912, “cunning” 914, “clear” 916) can appear as shown in FIG. 9B. The set of suggestions can be provided in list form. The particular words (or phrases) provided in the set of suggestions are based on the terms that appear in the index 520 that satisfy a condition with respect to the at least one character from the input 900.

A user can select one of the suggestions or continue to enter additional characters. The search feature 404 may initiate a search using the selected suggestion. The manner in which the results of the search are brought in to the content creation or consumption application can be any suitable manner available to the application. Non-limiting examples include a results window or a results panel.

Although text input is shown, in some cases, the search input can be received via audio (and be partial terms, whole terms, or phrases).

In some cases, suggestions can be provided prior to receipt of the input of the at least one character. These prior-to-at-least-one-character suggestions can be based on criteria with respect to the content of the file. In some cases, entities from the file (for example as indicated in the index) can be ranked based upon characteristics of the content. Examples of characteristics of the content include position and/or markup in the file. As an illustrative example, entities that are from a headings part of a document can be ranked higher than entities from body paragraphs. As another illustrative example, entities extracted from a start of content of a file can be ranked higher than entities extracted from farther into the file. As yet another illustrative example, formatting markup, such as bolded font, may be used to rank an entity higher. Once the entities are ranked, that information can be used to inform what is shown in the “zero term” state. If the insertion point is located in a particular point in the document, the location of that insertion point may be used to inform the suggestions.

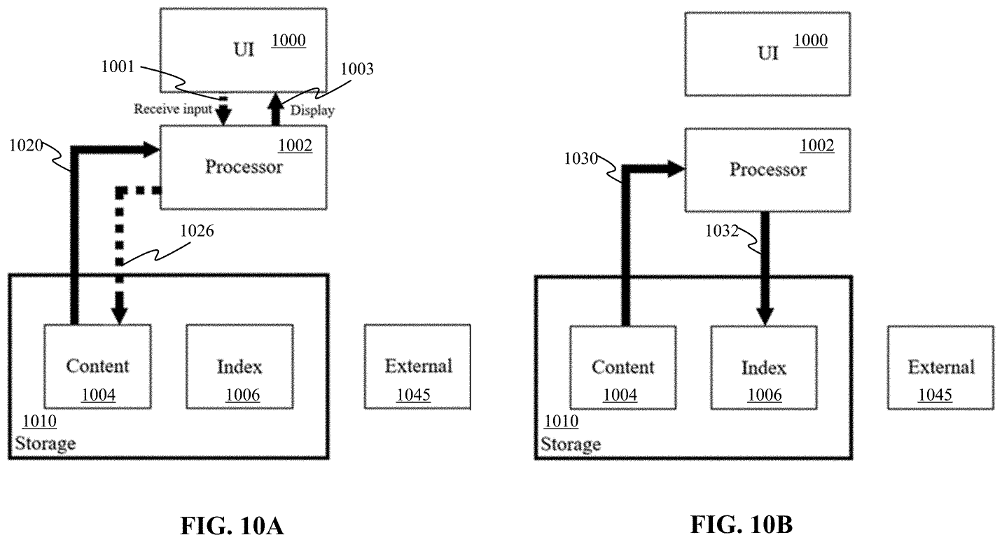

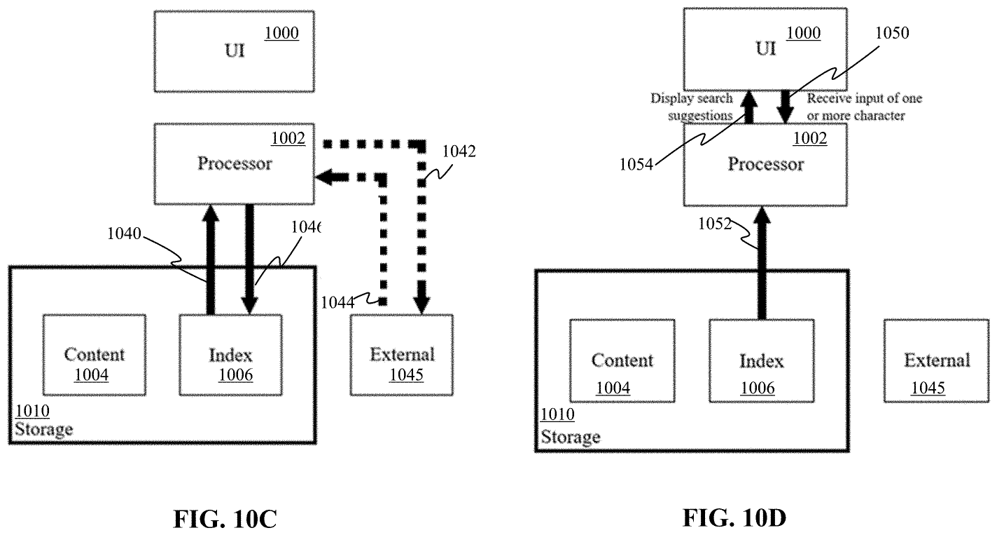

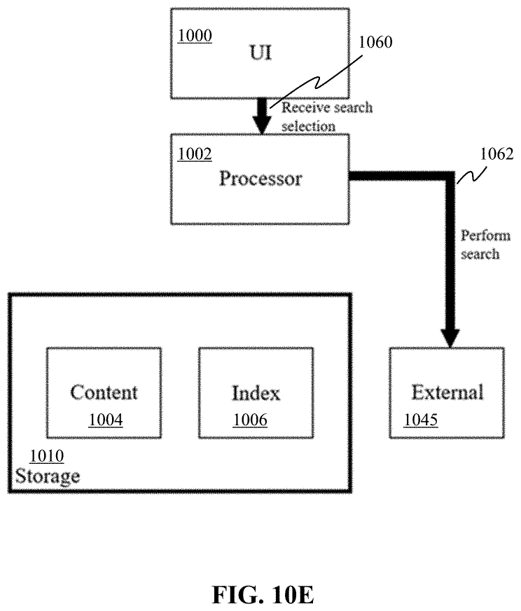

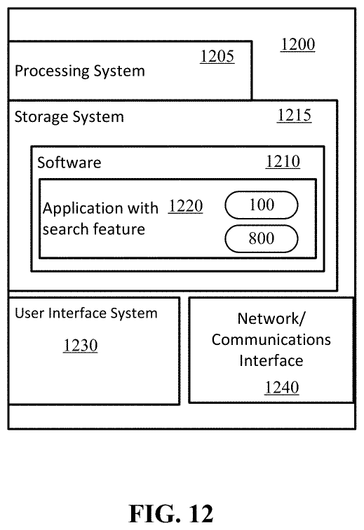

FIGS. 10A-10E illustrate an example system and operations for content-aware search suggestions. In detail, a system in which the described content-aware search suggestions may be carried out can include a processor 1002 and storage 1010. The processor 1002 executes instructions stored in the storage 1010 to direct the system to perform processes such as processes 100 and 800. Storage 1010 can store content 1004 and index 1006. Storage 1010 may be any suitable storage media such as described with respect to storage system 1215 of FIG. 12.

Referring to FIG. 10A, content 1004 can be displayed in a user interface (UI) 1000 of an application. UI 1000 can receive (1001) input from a user and display (1003) content to a user. Processor 1002 can retrieve the content 1004 from the storage 1010 and provide the content for display (1003) in the UI 1000. Changes to the content made by the user can be received (1001) via the UI 1000 and stored (1026) as part of the content in storage 1010. When the user views the content or otherwise interacts with the content, process 100 (e.g., operations 102, 104, 106, 108) may initiate. The operations 102, 104, 106, 108 can be performed continually, continuously, after one or more modifications to the content, at predetermined intervals, or upon other criteria.

For example, the system can perform entity extraction on content in a file that a user is consuming, authoring, or editing. Referring to FIG. 10B, the processor 1002 can process (1030) the content 1004 for entity extraction (e.g., operation 104); and store (1032) the entities as terms in index 1006 (e.g., operation 106).

As illustrated in FIG. 10C, the system can generate terms related to the extracted entities and store the terms in the index (1042) (e.g., operation 108). For example, the processor 1002 obtains (1040) the terms 1040 from the index 1010; and performs semantic analysis such as described with respect to FIG. 7. In various implementations, the semantic analysis is carried out in whole or in part by instructions executed by processor 1002. In some cases, semantic analysis can be carried out by a separate service which may be executed external 1045 to system with processor 1002. For example, a request (1042) can be made to an external system 1045 so as to obtain related terms to those extracted from the content (e.g., received at 1044). The received terms can be stored (1046) as part of the index 1006. In some cases, system with processor 1002 can communicate with an external system 1045 to obtain additional content from which entities can be extracted (e.g., content indicated as related to content 1006 through relationships identified on an enterprise or social graph or associated with content 1006 through an author-created corpus as discussed above and in more detail with respect to FIGS. 3A and 3B).

When a modification to the content in the file is received, the system can update the index 1010. For example, when the modification is an addition of new content, the system can extract entities identified from the new content (by recognizing the delta or by performing the extraction process to the content as a whole) and generate terms related to the extracted entities. When the modification is a removal of existing content, the system may update the index to remove certain terms and phrases. For example, the system may recreate the index or identify the deltas and remove the terms and phrases no longer found or relevant to the current state of the content.

Turning now to FIG. 10D, when the system receives (1050) an input of at least one character in a search field (e.g., operation 802), a set of suggestions can be provided (1054) to the user via the UI 1000 based on the terms that appear in the index 1006 (1052) that satisfy a condition with respect to the at least one character from the input (e.g., operation 804). For example, the processor 1002 can use the terms from the index 1006 to determine set of search suggestions.

The conditions to satisfy the determination of search suggestions can have a variety of implementations. For example, consider the case that “gi” is typed into the search bar. The condition could be an exact match. The match could be exclusively at the front of the word. In our example, the system would check all the words in the index and return all terms that begin with the characters “gi,” such as ‘giant’ or ‘gigabyte’. An exact match could be required, but be anywhere within the word, such as ‘beginning’ or ‘legitimate’. The condition could also allow for some slight variation. For instance, one character could be required to match exactly, but the other character may be afforded some leniency. This leniency could be useful in helping the user in the case of a typographical error. For instance, the edit distance could allow one character of error and this edit distance could preferentially treat substitutions that are close on a keyboard. For example, the input ‘q’ could allow for a word beginning with ‘w’, ‘a’, or ‘s’ in addition to ‘q’ itself. The order of the terms that appear as suggestions can also be curated by the application. For instance, if a word appeared multiple times, the term could be pushed to the top of the suggestion. In some cases, there can be a more generic amount of edit distance that is irrespective of keyboard layout that determines which other possible search terms were intended. In some cases, the search term can be determined instead by doing a dictionary lookup on terms matching the inputted characters and then matching to semantically similar terms in the index

The process illustrated in FIG. 10D can continuously be performed to allow for continuous updating of search suggestions as more characters are added or removed to the search field. In response to receiving at least one additional character in the search field (e.g., operation 1020), the system can provide an updated set of suggestions based on the terms that appear in the index that satisfy the condition with respect to the at least one character from the input (e.g., operation 808). This process can occur iteratively until an explicit search request (e.g., hitting “enter” to execute the search) is made or until the user has made a selection. A similar process can also allow for the search suggestions to be generated when characters are removed.

Referring to FIG. 10E, the system can accept a selection of a suggestion. When the selection is received (1060), the selection can be sent to the external resource 1008 being searched upon (1062). Optionally, the selection can be saved for comparison against the suggestions for improvement.

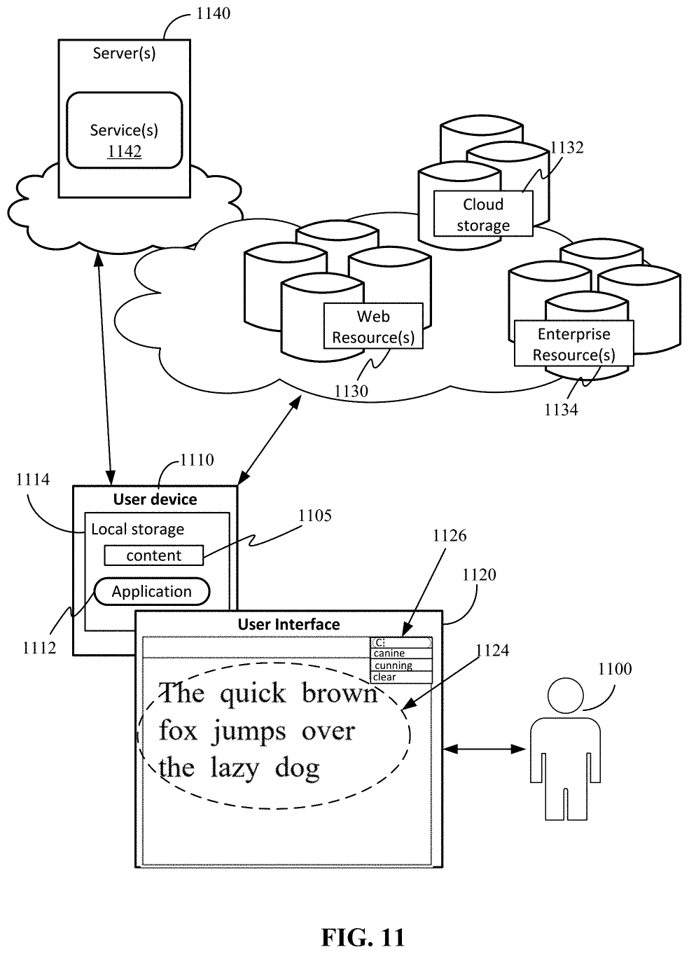

FIG. 11 illustrates an operating environment for content-aware search suggestions. Referring to FIG. 11, a user 1100 can access content 1105 on a computing device 1110, which may be embodied as described with respect to computing system 1200 of FIG. 12. Content 1105 can be viewed, and in some cases edited, through a content consumption or creation application 1112 via an interface 1120 of the application 1112. The interface 1120 can be similar to that described with respect to UI 400A, 400B of FIGS. 1A-1B and 9A-9B, and display the content 1105, which may include text 1124 and images; as well as include search feature 1126, which may operate such as described with respect to search feature 404 of FIGS. 1A and 9A-9B.

Content 1105 may be stored locally at the local storage 1114 of computing device 1110 or available via web resources 1130, cloud storage 1132, or enterprise resources 1134. In some cases, the index generated for the content-aware search suggestions is stored in the local storage 1114. In some cases, the index is located at a web resource, cloud storage, or enterprise resource.

Computing device 1110 can communicate with one or more servers 1140 so that application 1112 can utilize any number of services 1142 external to computing device 1110. Example services 1142 could include entity extraction services, STT, index curation, or related term generation. Depending on implementation, search feature 1126 may involve one or more services for performing the search of online or offline resources.

FIG. 12 shows an example computing system that may carry out the described content-aware search suggestions. Referring to FIG. 12, system 1200 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen. Accordingly, more or fewer elements described with respect to system 1200 may be incorporated to implement a particular computing device.

System 1200 includes a processing system 1205 of one or more hardware processors to transform or manipulate data according to the instructions of software 1210 stored on a storage system 1215. Examples of processors of the processing system 1205 include general purpose central processing units (CPUs), graphics processing units (GPUs), field programmable gate arrays (FPGAs), application specific processors, and logic devices, as well as any other type of processing device, combinations, or variations thereof. The processing system 1205 may be, or is included in, a system-on-chip (SoC) along with one or more other components such as network connectivity components, sensors, video display components.

The software 1210 can include an operating system (OS) and application programs, including an application with search feature 1220. Application 1220 can perform process 100 as described with respect to FIG. 1 and process 800 as described with respect to FIG. 8. Application 1220 may be a content consumption application, a content creation application or other productivity application, or even a browser. In some cases, application 1220 can be a widget or add-on to other applications or viewers.

Storage system 1215 may comprise any computer readable storage media readable by the processing system 1205 and capable of storing software 1210 including the application 1220.

Storage system 1215 may include volatile and nonvolatile memories, removable and non-removable media implemented in any method or technology for storage of information, such as computer readable instructions, data structures, program modules, or other data. Examples of storage media of storage system 1215 include random access memory, read only memory, magnetic disks, optical disks, CDs, DVDs, flash memory, magnetic cassettes, magnetic tape, magnetic disk storage or other magnetic storage devices, or any other suitable storage media. In no case does “storage media” consist of transitory, propagating signals.

Storage system 1215 may be implemented as a single storage device but may also be implemented across multiple storage devices or sub-systems co-located or distributed relative to each other. Storage system 1215 may include additional elements, such as a controller, capable of communicating with processing system 1205.

The system can further include user interface system 1230, which may include input/output (I/O) devices and components that enable communication between a user and the system 1200. User interface system 1230 can include one or more input devices such as, but not limited to, a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 1230 may also include one or more output devices such as, but not limited to, display screen(s), speakers, haptic devices for tactile feedback, and other types of output devices. In certain cases, the input and output devices may be combined in a single device, such as a touchscreen display which both depicts images and receives touch gesture input from the user.

A natural user interface (NUI) may be included as part of the user interface system 1230 for a user (e.g., user 1100) to input characters into a search field. Examples of NUI methods include those relying on speech recognition, touch and stylus recognition, gesture recognition both on screen and adjacent to the screen, air gestures, head and eye tracking, voice and speech, vision, touch, hover, gestures, and machine intelligence. Accordingly, the systems described herein may include touch sensitive displays, voice and speech recognition, intention and goal understanding, motion gesture detection using depth cameras (such as stereoscopic or time-of-flight camera systems, infrared camera systems, red-green-blue (RGB) camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

Visual output may be depicted on a display of the user interface system 1230 in myriad ways, presenting graphical user interface elements, text, images, video, notifications, virtual buttons, virtual keyboards, or any other type of information capable of being depicted in visual form.

The user interface system 1230 may also include user interface software and associated software (e.g., for graphics chips and input devices) executed by the OS in support of the various user input and output devices. The associated software assists the OS in communicating user interface hardware events to application programs using defined mechanisms. The user interface system 1230 including user interface software may support a graphical user interface, a natural user interface, or any other type of user interface.

Network interface 1240 may include communications connections and devices that allow for communication with other computing systems over one or more communication networks. Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Alternatively, or in addition, the functionality, methods and processes described herein (e.g., 100 as described with respect to FIGS. 1 and 800 as described with respect to FIG. 8) can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
performing entity extraction on content in a file that a user is consuming or authoring or editing;
storing the extracted entities in an index;
generating terms and phrases related to the extracted entities and storing the terms and phrases in the index; and
in response to receiving an input of at least one character in a search field:
providing a set of search suggestions based on the terms and phrases that appear in the index that satisfy a condition with respect to the at least one character from the input.

2. The method of claim 1, further comprising:
receiving a modification to the content in the file, wherein the modification comprises an addition of new content or removal of existing content; and
updating the index based on the modification to the content in the file.

3. The method of claim 1, further comprising:
in response to receiving at least one additional character in the search field:
providing an updated set of search suggestions based on the terms and phrases that appear in the index.

4. The method of claim 1, wherein the index is stored as metadata associated with the file.

5. The method of claim 1, wherein the entity extraction is performed on all words in the file.

6. The method of claim 1, wherein the entity extraction is performed on some subset of the content in the file.

7. The method of claim 1, further comprising:
identifying other files as related files with respect to the file; and
performing entity extraction on related files.

8. A system comprising:
a processor;
storage;
instructions stored in the storage that when executed by the processor, direct the system to:
perform entity extraction on content in a file that a user is consuming, authoring, or editing;
store the extracted entities in an index in the storage;
generate terms and phrases related to the extracted entities and storing the terms and phrases in the index; and
in response to receiving an input of at least one character in a search field:
provide a set of search suggestions based on the terms and phrases that appear in the index that satisfy a condition with respect to the at least one character from the input.

9. The system of claim 8, further comprising instructions stored in the storage that further direct the system to:
in response to receiving at least one additional character in the search field:
provide an updated set of search suggestions based on the terms and phrases that appear in the index.

10. The system of claim 8, wherein the index is stored as metadata associated with the file.

11. The system of claim 8, wherein the entity extraction is performed on all content in the file.

12. The system of claim 8, wherein the entity extraction is performed on a subset of the content in the file.

13. The system of claim 8, wherein the content comprises images.

14. The system of claim 8, further comprising instructions stored in the storage that further direct the system to:
identify other files as related files with respect to the file; and
perform entity extraction on related files.

15. A computer-readable storage medium having instructions stored thereon that when executed by a computing system direct the computing system to:
perform entity extraction on content in a file that a user is consuming, authoring, or editing;
store the extracted entities in an index in the storage;
generate terms and phrases related to the extracted entities and storing the terms and phrases in the index;
in response to receiving an input of at least one character in a search field:
provide a set of search suggestions based on the terms and phrases that appear in the index that satisfy a condition with respect to the at least one character from the input; and
in response to receiving at least one additional character in the search field:
provide an updated set of search suggestions based on the terms and phrases that appear in the index.

16. The medium of claim 15, wherein the index is stored as metadata associated with the file.

17. The medium of claim 15, wherein the entity extraction is performed on all content in the file.

18. The medium of claim 15, wherein the entity extraction is performed on a subset of the content in the file.

19. The medium of claim 15, further comprising instructions stored thereon that when executed further direct the computing system to:
rank entities extracted from the content according to characteristics of the content: and
provide suggestions using the rank of the entities prior to receiving the input of at least one character in the search field.

20. The medium of claim 15, further comprising instructions stored thereon that when executed further direct the computing system to:
identify other files as related files with respect to the file; and
perform entity extraction on related files.
